(19) United States
(12) Patent Application Publication
(10) Pub. No.: US 2014/0151210 A1
(43) Pub. Date: Jun. 5, 2014

(54) ILLUMINATED KEYBOARD EQUIPPED WITH LIGHT EMITTING KEYCAPS

(71) Applicant: ZIPPY TECHNOLOGY CORP., New Taipei City (TW)

(72) Inventor: Chin-Wen CHOU, New Taipei City (TW)

(73) Assignee: ZIPPY TECHNOLOGY CORP., New Taipei City (TW)

(21) Appl. No.: 13/692,780

(22) Filed: Dec. 3, 2012

(51) Int. Cl. H01H 13/83

(52) U.S. Cl. CPC H01H 13/83
USPC 200/5 A

(57) ABSTRACT

An illuminated keyboard equipped with light emitting keycaps includes a keyboard portion and a light emitting portion. The keyboard portion includes at least one circuit board contained a plurality of keyboard command portions and a plurality of press members located above the circuit board corresponding to the keyboard command portions that are depressible to trigger the keyboard command portions. Each press member has a press surface, a holding surface and a coupling surface interposed between the press surface and holding surface. The press surface and circuit board form a light projection zone therebetween. The light emitting portion includes a lighting unit to provide light to the light projection zone and a light mask plate. The light mask plate has an aperture to expose the press surface and a light mask portion overlapped over the holding surface.

### FIELD OF THE INVENTION

The present invention relates to an illuminated keyboard equipped with light emitting keycaps and particularly to an illuminated keyboard containing a light mask plate overlapped over a holding surface of a press member to mask light projecting to the holding surface and confine the light to project merely to a press surface and a coupling surface.

### BACKGROUND OF THE INVENTION

In a computer system, whether a desktop computer or notebook computer, keyboard is the main command input equipment. Design of the keyboard mainly focuses on making users to enter input commands comfortably and accurately. In a dim environment for users who are not familiar with notations or characters on the keycaps accurate entering of the input commands is difficult. In order to enable the users to clearly distinguish the notations or characters on the keycaps in the dim environment illuminated keyboards have been developed and introduced, such as U.S. Pat. Nos. 6,284,988, 6,322,229, 6,199,996, 6,554,442 and 6,179,432, and Taiwan patent Nos. 509955, 465777, 535385, 438035, 570235, 468833 and 516671. They all provide an illuminated keyboard with an embedded light emitting sheet to project light to allow users to accurately judge keyboard characters in a dim environment.

The aforesaid prior techniques mostly have the keycaps, elastic elements and driven mechanisms made from transparent material, or the keycap made in opaque with the transparent character notation on the keycap. Light emitting element generates light projection on an entire sheet to project the light evenly to the keyboard. Such a lighting approach creates problems for users in use, as uniform light emission of the keyboard creates too strong of total luminosity that upsets users' vision in a dim environment, and makes distinguishing of character notation on each keycap difficult. Even if light is projected through merely the character notation or masked, light emitted from neighboring keycaps could still create visual interference and make distinguishing difficult. To users who are not familiar with the character notation layout of the keyboard, the aforesaid problem remains an issue to be overcome.

In view of the aforesaid problem, the Applicant proposed a non-uniform light projection illuminated keyboard in R.O.C. patent I230957. It has a mask element located between a keycap and a lighting element. The mask element has a transparent zone corresponding to an individual keycap and an opaque zone below neighboring keycaps but outside the individual keycap, thereby forms non-uniform light projection to overcome the problem of viewing difficulty caused by too strong of luminosity of the total keyboard. However, in addition to the aforesaid concern, nowadays thin and lightweight has become the prevailing trend of the keyboard structure. Aside from reducing the thickness of the keyboard, thinner keyboards without the driven mechanism or elastic element also have been developed.

### SUMMARY OF THE INVENTION

The primary object of the present invention is to provide a non-uniform lighting illuminated keyboard that also is thinner and lighter in weight.

To achieve the foregoing object the present invention provides an illuminated board equipped with light emitting keycaps. The illuminated keyboard includes a keyboard portion and a light emitting portion. The keyboard portion includes at least one circuit board contained a plurality of keyboard command portions and a plurality of press members located on the circuit board corresponding to the keyboard command portions that are depressible by users to trigger the keyboard command portions. Each press member has a press surface, a holding surface and a coupling surface interposed between the press surface and holding surface. The press surface and circuit board form a light projection zone between them. The light emitting portion includes a lighting unit to provide light to the light projection zone and a light mask plate. The light mask plate has an aperture to expose the press surface and a light mask portion overlapped over the holding surface. The light mask portion masks light projected from the light projection zone to the holding surface to confine light projection merely to the press surface and coupling surface.

In one embodiment the coupling surface is an inclined surface or vertical surface.

In another embodiment the keyboard portion has a connection arm connecting to bottom edges of the coupling surfaces of abutting press members and forming the holding surface.

In yet another embodiment the coupling surface of the press member has a bottom edge horizontally extending toward the abutting press member of the press surface to form the holding surface.

In yet another embodiment the press surface further includes a transparent zone and an opaque zone; more specifically, the transparent zone is a character notation.

In yet another embodiment the coupling surface can be a transparent surface or an opaque surface.

In yet another embodiment the keyboard portion includes an elastic support member to aid the press member to move against the circuit board.

In yet another embodiment the circuit board includes an opaque layer corresponding to the press member and light mask plate; more specifically, the opaque layer is a reflective layer.

Through the aforesaid structure, compared with the conventional illuminated keyboards, the invention can provide advantages of non-uniform illumination and thinner and lighter in weight. The invention, with the light mask plate located above the holding surface, and the light mask portion masked the light projecting to the holding surface, can confine the light to project merely to the press surface and coupling surface to form non-uniform illumination. Moreover, the illuminated keyboard of the invention does not have a driven mechanism, hence the keyboard can be made thinner.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the illuminated keyboard of the invention.

FIG. 2A is a schematic side view of the first embodiment of the illuminated keyboard of the invention.

FIG. 2B is a fragmentary enlarged side view of the first embodiment of the illuminated keyboard of the invention

FIG. 3 is a schematic side view of a second embodiment of the illuminated keyboard of the invention.

FIG. 4 is an exploded view of a third embodiment of the illuminated keyboard of the invention.

FIG. 5 is a schematic side view of the third embodiment of the illuminated keyboard of the invention.

### DETAILED DESCRIPTION OF THE PREFERRED EMBODIMENTS

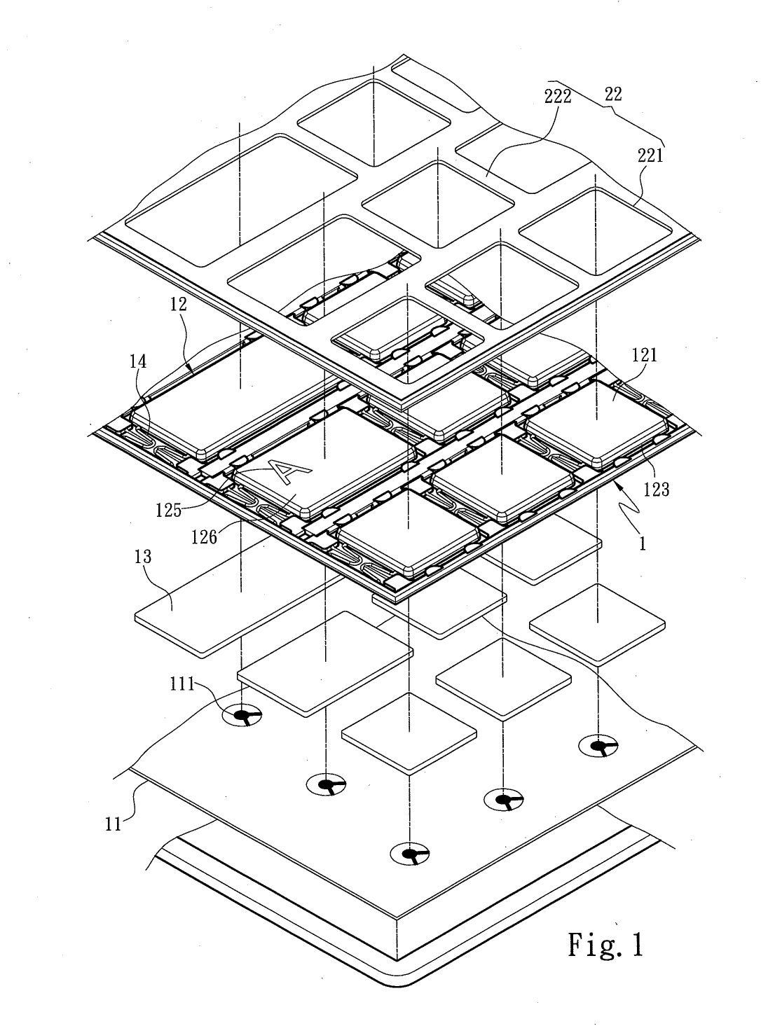

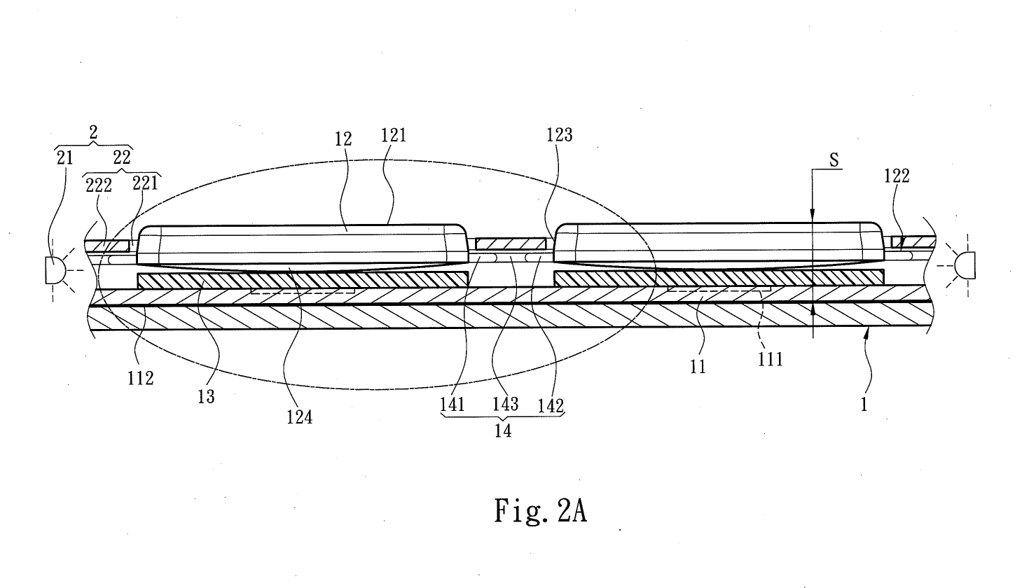

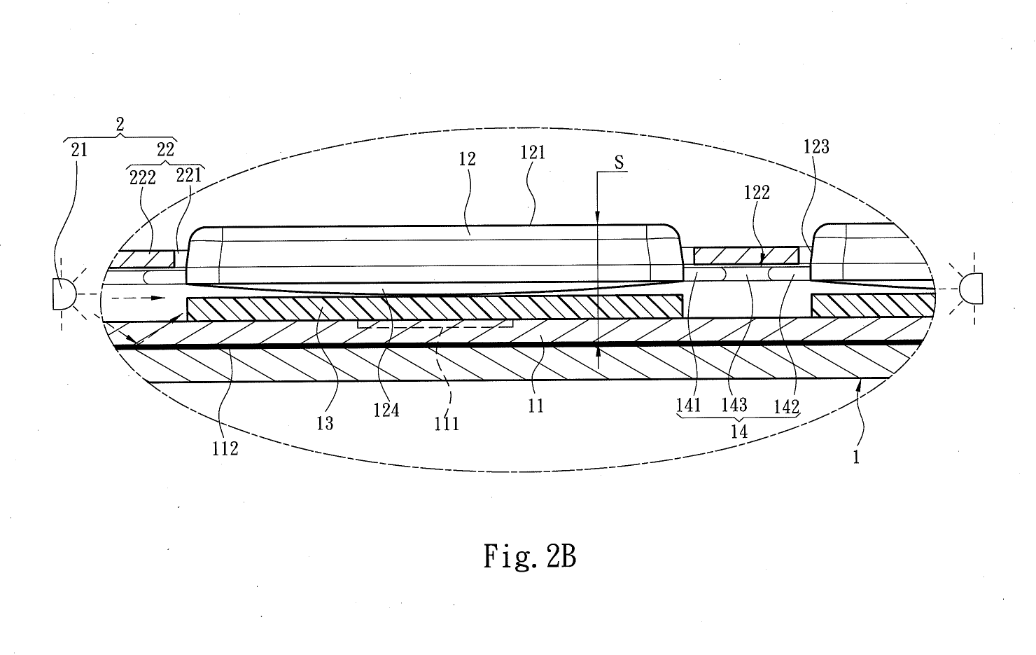

Please referring to FIGS. 1, 2A and 2B, the present invention aims to provide an illuminated keyboard equipped with light emitting keycaps. It includes a keyboard portion 1 and a light emitting portion 2. The keyboard portion 1 includes at least one circuit board 11 and a plurality of press members 12 located on the circuit board 11. More specifically, the circuit board 11 has a plurality of keyboard command portions 111 which can be triggered to generate corresponding keyboard commands. Each press member 12 has a press surface 121, a holding surface 122 and a coupling surface 123 interposed between the press surface 121 and holding surface 122. The press surface 121 and circuit board 11 form a light projection zone S between them. The press member 12 further has a trigger portion 124 extended towards the circuit board 11. The press member 12 is depressible by a user to move towards the circuit board 11, and the trigger portion 124 connects the keyboard command portion 111 to generate a keyboard command. The press member 12 and circuit board 11 also are interposed by an elastic support member 13 to aid the press member 12 to move against the circuit board 11. The elastic support member 13 can be a sponge or a flexible dome. The light emitting portion 2 includes a lighting unit 21 to provide light to the light projection zone S and a light mask plate 22. The lighting unit 21 can be formed in various fashions in implementation, such as a light emitting diode (LED) or light emitting strip located at two sides of the light projection zone S or in the light projection zone S, this is not the limitation of the invention; as it is not the main focus of the invention, details are omitted herein. The light mask plate 22 includes an aperture 221 to expose the press surface 121 and a light mask portion 222 overlapped over the holding surface 122. Light emitted from the lighting unit 21 is transmitted in the light projection zone S. The light mask portion 222 masks the light in the light projection zone S projecting to the holding surface 122 and confines the light to project merely to the press surface 121 and coupling surface 123.

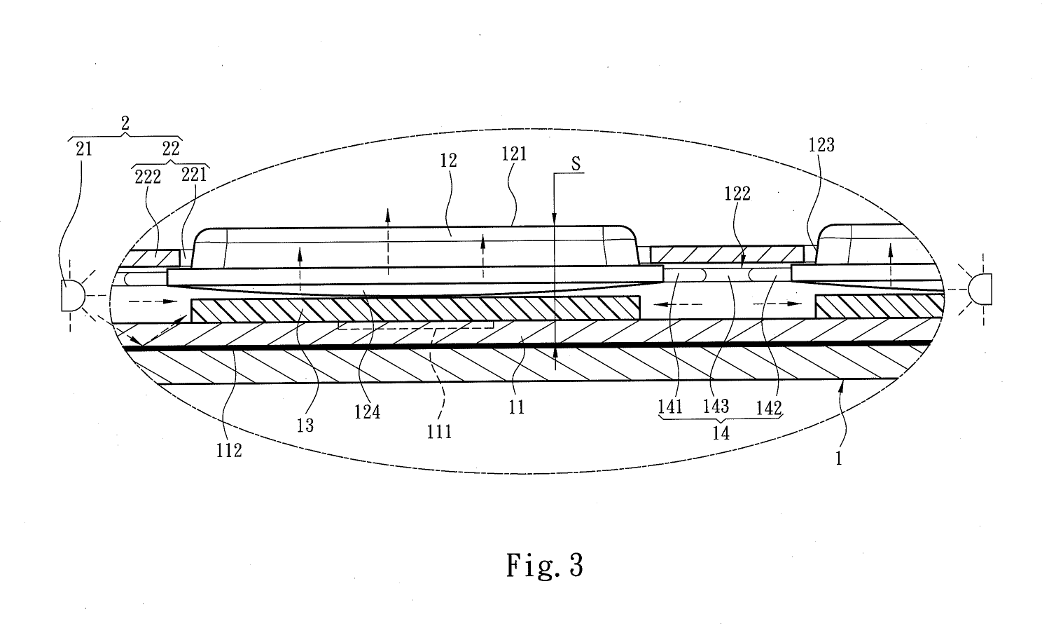

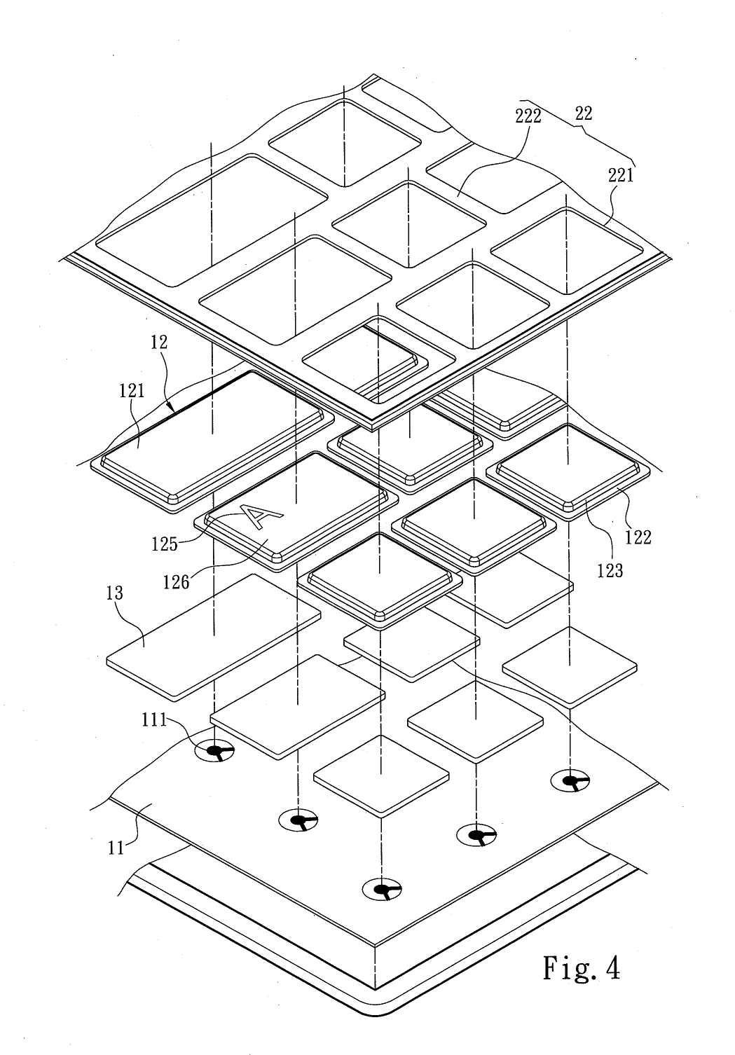

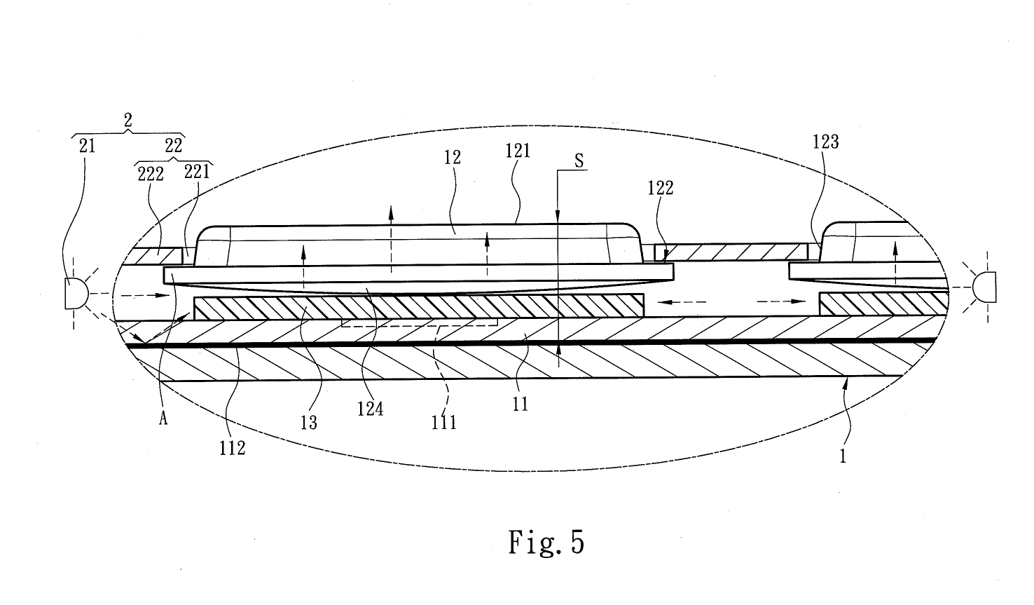

Please also referring to FIGS. 1 and 3, there are numerous types of press members 12 adopted in the industry. In terms of the coupling surface 123 connecting to the press surface 121 and holding surface 122, it can be an inclined or vertical surface. The press member 12 depicted in the drawings serves merely for illustrative purpose and is not the limitation of the invention. More specifically, the keyboard portion 1 has a connection arm 14 connecting to bottom edges of the coupling surfaces 123 of abutting press members 12 and forming the holding surface 122. The connection arm 14 includes a first connecting section 141 and a second connecting section 142 to connect to the abutting press members 12 and an elastic section 143 to bridge the first and second connecting sections 142 and 143 to serve as a stress buffer spot. The light mask portion 222 of the light mask plate 22 is overlapped over the connection arm 14 to mask the light in the light projection zone S projecting to the connection arm 14. In another embodiment of the holding surface 122, referring to FIGS. 4 and 5, the coupling surface 123 of the press member 12 has a bottom edge horizontally extending toward the abutting press member 12 of the press surface 121 to form the holding surface 122., and the light mask portion 222 is overlapped over a distal end A extended horizontally from the bottom edge of the coupling surface 123. More specifically, the distal end A, aside from overlapped over the light mask plate 22, also confines the location and movement of the press member 12 on the keyboard portion 1.

Please referring to FIG. 1, the press surface 121 can also include a transparent zone 125 and an opaque zone 126. In the event that the press surface 121 is a transparent surface, the opaque zone 126 is located on the press surface 121 coated with an opaque pigment or material to block the light from passing through. More specifically, the transparent zone 125 can be a character notation on the press surface 121. The invention, aside from selectively forming a transparent or light masking location on the press surface 121 as required, can also form a transparent surface or opaque surface on the coupling surface 123. In addition, the circuit board 11 can also include an opaque layer 112 corresponding to the press member 12 and light mask plate 22. The opaque layer 112 confines the light in the light projection zone S from passing through the circuit board 11, and transmits only in the light projection zone S. The opaque layer 112 can be a reflective layer to reflect the light in the light projection zone S towards the press surface 121.

As a conclusion, the illuminated keyboard equipped with light emitting keycaps of the invention has the light mask plate above the holding surface of the press member, and a light mask portion overlapped over the holding surface to mask the light from projecting to the holding surface, thereby confines light projection merely to the press surface and coupling surface to form non-uniform illumination. The illuminated keyboard thus formed does not have driven mechanisms used in the conventional keyboards, hence can be made thinner.

While the preferred embodiments of the invention have been set forth for the purpose of disclosure, they are not the limitations of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An illuminated keyboard equipped with light emitting keycaps, comprising:
a keyboard portion including at least one circuit board contained a plurality of keyboard command portions and a plurality of press members located above the circuit board corresponding to the keyboard command portions and depressible to trigger the keyboard command portions, each press member including a press surface, a holding surface and a coupling surface interposed between the press surface and the holding surface, the press surface and the circuit board forming a light projection zone therebetween; and
a light emitting portion including a lighting unit to provide light to the light projection zone and a light mask plate which includes an aperture to expose the press surface and a light mask portion overlapped over the holding surface, the light mask portion masking light in the light projection zone projected towards the holding surface and confining the light in the light projection zone to project merely to the press surface and the coupling surface.

2. The illuminated keyboard of claim 1, wherein the coupling surface is an inclined surface.

3. The illuminated keyboard of claim 2, wherein the keyboard portion has a connection arm connecting to bottom edges of the coupling surfaces of abutting members and forming the holding surface.

4. The illuminated keyboard of claim 2, wherein the coupling surface of the press member has a bottom edge horizontally extending toward the abutting press member of the press surface to form the holding surface.

5. The illuminated keyboard of claim 1, wherein the coupling surface is a vertical surface.

6. The illuminated keyboard of claim 5, wherein the keyboard portion has a connection arm connecting to bottom edges of the coupling surfaces of abutting members and forming the holding surface.

7. The illuminated keyboard of claim 5, wherein the coupling surface of the press member has a bottom edge horizontally extending toward the abutting press member of the press surface to form the holding surface.

8. The illuminated keyboard of claim 1, wherein the press surface further includes a transparent zone and an opaque zone.

9. The illuminated keyboard of claim 8, wherein the transparent zone is a character notation.

10. The illuminated keyboard of claim 1, wherein the coupling surface is a transparent surface.

11. The illuminated keyboard of claim 1, wherein the coupling surface is an opaque surface.

12. The illuminated keyboard of claim 1, wherein the keyboard portion includes an elastic support member to aid the press member to move against the circuit board.

13. The illuminated keyboard of claim 1, wherein the circuit board includes an opaque layer corresponding to the press member and the light mask plate.

14. The illuminated keyboard of claim 13, wherein the opaque layer is a reflective layer.
